(19) United States
(12) Patent Application Publication
(10) Pub. No.: US 2011/0006519 A1
(43) Pub. Date: Jan. 13, 2011

(54) Screw Connection

(76) Inventor: Erwin Weh, Illertissen (DE)

Correspondence Address: PITTS AND BRITTIAN P C, P O BOX 51295, KNOXVILLE, TN, 37950-1295, US

(21) Appl. No.: 12/867,853

(22) PCT Filed: Feb. 12, 2009
(86) PCT No.: PCT/EP09/00957

§ 371 Date: Sep. 30, 2010

(30) Foreign Application Priority Data
Feb. 15, 2008 (DE) 20 2008 002 211.8

(51) Int. Cl. F16L 19/02

(52) U.S. Cl. 285/355

(57) ABSTRACT

The invention relates to a screw connection (1), in particular a high-pressure screw connection for the transfer of gaseous, liquid and/or solid media, in particular for refuelling vehicles, comprising a hollow body (9), in particular a tubular body, which is surrounded at least partially by a sealing sleeve (4). The screw connection is characterized in that the sealing sleeve (4) is cohesively connected to the tubular body (9).

The invention relates to a screw connection, especially a high-pressure screw connection for the transfer of gaseous, liquid and/or solid media.

A secure transfer of a medium from a pressure source or a pressure reservoir such as a hydraulic pump or a refueling system is to be achieved with such screw connections which are also suitable for lower pressure ranges. The important aspect is the leakage-free arrangement in order to prevent the leakage of medium to the ambient environment.

Such a high-pressure screw connection is described for example in EP-A-0 753 698 for pressure conduits or in WO 02/01105 for pipe screws. Such high-pressure screw connections with clamping rings are also the subject matter of the U.S. Pat. No. 3,584,900 or U.S. Pat. No. 3,103,373, with the arrangement of the clamping rings (cutting rings) being emphasized in order to ensure secure fixing of the connected pipes and their leakage-free sealing. At rising pressure values of more than 700 bars however, these pipe connections will become increasingly more sensitive to leakages, so that generally a leakage of media such as hydraulic oil or pre-cooled hydrogen gas can be expected. Accidents might happen in these cases. In particular, considerable damage could occur by leakages of pressurized lines. Moreover, the cutting rings which penetrate the outer shell of the pipes are a considerable burden on the pipe, so that a fissure or even breakage may occur in the case of alternating loads.

The invention is thus based on the object or providing a screw connection, especially a high-pressure screw connection, which avoids the disadvantages of the state of the art. In particular, a high-pressure screw connection will be provided which is improved in respect of security in combination with a simple configuration, so that hazards or damage are avoided.

This object is achieved by a screw connection, especially a high-pressure screw connection, which comprises at least one hollow body, especially a tubular body, which is surrounded at least partially by a sealing sleeve and is characterized in that the sealing sleeve is materially joined to the tubular body.

Preferred further developments of the invention are the subject matter of the subclaims.

In a special development of the invention, a high-pressure screw connection is provided for the transfer of gaseous and/or liquid media, especially for refueling vehicles, comprising a housing with a fluid passage and a sealing cone, and a tube that is inserted therein, the end of which is enclosed by an at least partly conical sealing sleeve which is axially pressurized by a nut, with a sealing sleeve being slid fully onto the tube and fixed at the tube end, and is especially welded together with a circular weld seam adjacent to the tube end.

In a further development of the embodiment, the sealing sleeve is enclosed by an annular chamber which opens into a vent bore.

Preferably, the sealing sleeve has an annular shoulder in which a sealing ring is inserted in a manner corresponding to the sealing cone of the housing.

Preferably an annular thread locker is provided between the sealing sleeve and the nut, which thread locker consists especially of two disks. In a further development of the embodiment, the end of the nut on the housing side encompasses the sealing sleeve and/or the thread locker in the axial direction.

Preferably, the housing can be arranged in a straight line, in a bent-off manner, as a T-element or as a crosspiece.

In a preferred embodiment, the sealing ring with conical outer shape consists of a pressure-resistant plastic, especially of PEEK, but it can also be made of NF (non-ferrous) metals such as aluminum alloys, monell, copper alloys or non-ferrous heavy metals.

It is especially preferable when the sealing sleeve is slid with a tight fit onto the tube, especially with a diameter tolerance of less than 1 mm, preferably <0.1 mm.

All measures as described above can be combined at will without requiring inventive step for the person skilled in the art.

As a result of the material connection of the sealing sleeve with the tube, a leakage-free connection even in the case of high pressures of more than 700 bar, especially more than 1000 bar and even more than 4000 bar, is achieved in contrast to connections according to the state of the art with cutting rings. Furthermore, the tubular body is relieved by the material connection. In particular, no axial loads occur. Furthermore, a deformation of the tubular body, and especially the tube, is prevented and a detachment from the connection is prevented. In the material connection, the permeation rate, i.e. the leakage rate, is determined substantially by the employed basic materials of the tubular body and the sealing sleeve.

Possible material connections between the pressure sleeve and the tubular body are all possible material connections such as a soldered connection, a welded connection, a glued connection, a press connection, a vulcanization connection or a shrink connection. Material connections are characterized in that the two connection partners are held together by atomic or molecular forces and can only be severed by the destruction of the connection means.

It is especially preferable when the material connection is produced between the sealing sleeve and the tubular body by a welding method, especially by laser welding.

On the outside of the sealing sleeve which faces away from the tubular body, the sealing sleeve comprises flutings, especially grooves. These grooves are used for holding a seal such as a sealing ring which is applied to the sealing sleeve. The sealing ring preferably engages in a sealing cone of a housing that partly encompasses the sealing sleeve and thus seals the sealing sleeve against the housing.

As a result of the grooves applied to the outside of the sealing sleeve, such a seal is fixed and a secure seat of the seal on the sealing sleeve is ensured. It is further ensured that the seal is securely held even when the screw connection is loosened. The application of the grooves on the outside of the sealing sleeve can occur either by metal-cutting methods or chipless forming. It is understood that other anchoring of the seal on the outside of the sealing sleeve is possible.

The tubular body which transfers the gaseous, fluid and/or solid medium can have a fitting contour on the side averted from the sealing sleeve. A flexible hose such as a hydraulic hose can be pulled onto the fitting contour.

In a further developed embodiment, the screw connection comprises a housing which has a fluid passage and a sealing cone. The sealing sleeve is inserted with the tubular body with which it is materially connected into said housing and is encompassed by the housing at least partially. Preferably, the housing comprises a sealing cone. The sealing cone and the sealing sleeve with inserted tube are connected with one another in a tight manner. This preferably occurs with a sealing ring which is applied to the sealing sleeve and engages in the sealing cone. The sealing sleeve can alternatively or additionally comprise a narrow conical area which forms a metallic sealing surface with the sealing cone of the housing. A metallic sealing is also achieved by such an embodiment when there is no sealing ring between the sealing sleeve and housing. The introduction of the conical area into the sealing sleeve can occur either by metal cutting or in a chipless way.

The seal as described above which is applied to the sealing sleeve and can be inserted into the sealing cone of the housing preferably comprises a sealing material which is softer than the basic material, which means the material of the tubular body or the housing. A sealing ring made of PEEK (polyether ether ketone) which has a high medium durability and tightness even at extreme minus temperatures of −75° C. for example. The geometry of the sealing ring is usually adjusted to that of the housing. A sealing of the sealing sleeve against the housing is achieved with the help of the sealing ring and/or the metallic seal.

The application of the sealing ring to the sealing sleeve can occur by pressing, an interlocking or material connection, by spraying on, vulcanizing, bonding or gluing.

Preferably, the screw connection comprises a tensioning screw with which the housing is screwed together with the sealing sleeve. The tensioning screw represents a frictional connection between the tensioning screw, the securing element introduced between the tensioning screw and the sealing sleeve, and the sealing sleeve. Materials for the tensioning screw are considered to be special steel, and also light and non-ferrous heavy metals and plastic materials such as aluminum alloys, brass alloys, POM or PVDF. The machining of the tensioning screw occurs either by means of metal cutting or by chipless forming.

In order to prevent the loosening of the threaded fitting, comprising tube, seal, sealing sleeve, tensioning screw and securing disk in the present case, in the case of unfavorable mechanical loads, a thread locker can be provided which preferably consists of two disks which are arranged to be movable in relation to one another.

The screw-release torque is increased by such a securing system.

In order to prevent an undesirable pressure build-up in the housing, it can be provided that the housing comprises a vent bore or a notch which is introduced into the thread of the housing part. The vent bore further allows undertaking leakage measurements.

The preferred material for the housing is light-metal alloys and all metallic and non-metallic materials. Otherwise, all possible combinations of materials are possible. It is advantageous when there is a very precise fit, which means narrow tolerance, in the region of the sealing sleeve and the nut, or the tensioning screw, so that the tubular body is not subjected to any bending loads in the sealing sleeve and also in the nut. Diameter tolerances of less than 1 mm, preferably less than 0.1 mm, are especially preferred.

The screw connection, especially high-pressure screw connection, is characterized by an especially high amount of security and simple configuration because a simple connection is achieved by the proposed fixing of the sealing sleeve at the end of the tube, so that hazards or damage can be excluded. In particular, the tube is guided without any tensions in the sealing sleeve, so that tension peaks are prevented and it can be prevented in a secure and long-term manner with the proposed high-pressure screw connection that gas, fluids or solids can leak. This is especially important for reasons of protection from accidents, but also for reasons of environmental protection, so that no substantial volume of medium can be lost.

Notice must be taken that the proposed screw connection is suitable for different connections, especially for high-pressure systems or connections in the construction of vehicles, but also in industrial plants or for refueling motor vehicles. The screw connection, especially the high-pressure screw connection, can be installed at any position of the piping in a compact manner and can also comprise valves or filters adjacent to the screw connection.

An embodiment will be explained and described below in closer detail by reference to the enclosed drawing, wherein:

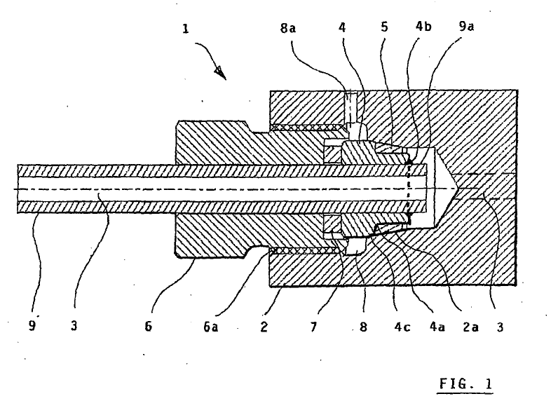

FIG. 1 shows a first embodiment of a high-pressure screw connection in a longitudinal sectional view;

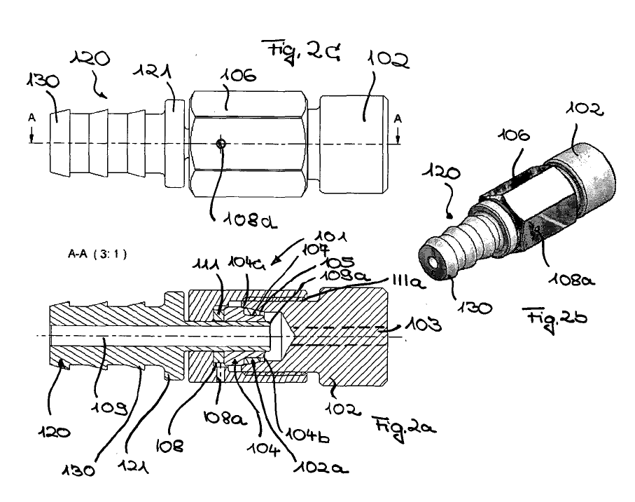

FIGS. 2a to 2c show a second embodiment of a high-pressure screw connection with a fitting.

FIG. 1 shows a first embodiment of a screw connection, especially a high-pressure screw connection 1 with a housing 2, with the right face side with a medium passage 3 shown by way of a broken line being used as an inlet for example and the left face side being used for further conveying the medium to be transferred via a tube 9 inserted therein, e.g. connected to a work cylinder or a pressure tank not shown here. A threaded nut 6 is provided on the left face side of the housing 2 which is screwed against the housing 2 via a thread 6a and a thread locker 7. The thread locker 7 preferably consists of two disks which are movable relative to one another, so that a loosening can be reliably prevented in the case of vibrations (e.g. in a motor vehicle).

A sealing sleeve 4 is provided in the interior of the housing 2, into which the tube 9 is inserted for continuing the medium passage 3 which is used as a conduit for feeding or discharging the medium to be transferred. The housing 2 can be arranged to be adjusted to the medium to be transferred, especially to the desired feed angle, lead-through cross sections, etc., e.g. also in an offset or bent manner or as a crosspiece.

The screw connection in accordance with the invention, especially the high-pressure screw connection 1, for the transfer of gaseous, fluid and/or solid media is characterized in that the sealing sleeve 4 is fixed at the tube end 9a, especially by a material connection. In particular, the sealing sleeve is welded together with a circular weld seam 4b with the tube end 9a, which is close to the entrance on the face side towards the medium passage 3. In the illustrated embodiment, the sealing sleeve is slid not only partly, but fully onto the tube 9. Furthermore, the sealing sleeve 4 has a narrow conical region 4c in the illustrated embodiment which forms a metallic sealing surface with the sealing cone 2a. Preferably, the sealing sleeve 4 is enclosed by an annular chamber 8 which opens into a vent bore 8a. An undesirable pressure build-up can thus be avoided.

In particular, the sealing sleeve 4 has an annular shoulder 4a in which a sealing ring 5 is inserted in a manner corresponding to the sealing cone 2a of the housing 2. Preferably, the sealing ring 5 with its conical outer shape is made of PEEK (polyether ether ketone) since this resistant material offers a high resistance to media and tightness even at extreme minus temperatures.

It is further advantageous that in the illustrated embodiment the end of the threaded nut 6 on the housing side encompasses the sealing sleeve 4 and/or the thread locker 7 in the axial direction. As a result, the end of the sealing sleeve 4 which has the larger diameter is encompassed and stabilized. Even when the tube 9 which faces to the left in this case is subjected to bending loads, the weld seam 4b at the tube end 9a will not be subjected to any bending stresses as a result of the precise guidance in the threaded nut 6 and especially due to the precise fit (narrow tolerance) in the sealing sleeve 4. As a result, even a relatively “fine” weld seam 4b is sufficient for secure fixing.

FIGS. 2a to 2c show an alternative development of the invention. The same components as in FIG. 1 are shown with reference numerals increased by 100.

In the longitudinal sectional view A-A according to FIG. 2a, a further embodiment of a screw connection 101 is shown, especially a high-pressure screw connection with a housing 102, with the housing having a fluid passage 103. The fluid passage 103 embedded in the housing 102 is used as an inlet for fluid for example which is further guided into the tube 109. As already in the embodiment according to FIG. 1, a sealing sleeve 104 is slid onto the tube 109 which is materially connected in accordance with the invention, e.g. by means of a weld seam 104b, to the tube end 109a. The sealing sleeve further comprises a conical region 104c which forms a metallic sealing surface in the region 103 with the sealing cone 102a which is embedded in the housing. In addition to the metallic sealing in the region 103 between the sealing cone 102a embedded in the housing and the conical region 104c of the sealing sleeve, the sealing sleeve comprises a region 107 which can have a fluting (not shown) for example. A sealing material is applied to the sealing cone in this region 107, e.g. by pressing or shrinking. The sealing material is preferably a sealing ring 105 which can consist of PEEK (polyether ether ketone). The sealing ring 105 seals the sealing sleeve in addition in relation to the housing.

As already shown in the embodiment according to FIG. 1, a threaded nut 106 is provided in the embodiment of FIGS. 2a to 2c which is preferably arranged as a tensioning screw. The tensioning screw is screwed against the housing 102 via a thread 111a which in the present case engages in an external thread of the housing 102 in contrast to the embodiment according to FIG. 1 and a thread locker 111. The thread locker 107 preferably consists of two disks which are movable relative to one another, so that loosening can securely be prevented in case of vibrations. The use of an external thread with which the threaded nut 106 is screwed together with the housing comes with the advantage that the connection can be used with existing media transfer systems such as tubes and hoses for example.

It can further be recognized that there is a vent bore 108a which is introduced into the threaded nut 106 and which opens into an annular chamber 108 which encloses the sealing sleeve 104. The vent bore 108a can prevent an undesirable pressure build-up in the case of a possibly occurring leakage in the sealing chamber. As a further difference, the embodiment according to FIGS. 2a to 2c has a fitting contour 120 on the side of the tube 109 which faces away from the housing, in contrast to the embodiment as shown in FIG. 1. The fitting contour comprises a stop 121 and a profiled section 130. A line such as a plastic line can be slid onto the profiled section and can be pressed with the fitting. It is thus possible to connect a flexible line to the screw connection in accordance with the invention, as described above by pressing.

FIG. 2b shows a three-dimensional view of a connection according to FIG. 2a and FIG. 2c shows a top view. The same components are shown with the same reference numerals as in the longitudinal sectional view along the line A-A in FIG. 2a.

The outside contour of the threaded nut 6 is clearly shown in FIGS. 2b to 2c, which is arranged as a polygonal screw. The vent bore 108a is also clearly shown, which is embedded in the outside wall of the threaded nut.

This configuration thus allows a simple mounting of the screw connection 1, especially the high-pressure screw connection, ensuring a secure connection and sealing even at very high pressures of up to 4000 bar and extreme temperature ranges in the plus and minus range of −100° C. to +150° C., especially −80° C. to +120° C.

1. A high-pressure screw connection for the transfer of gaseous, fluid and/or solid media, said high pressure screw connection comprising:
tubular body defining a fluid passage;
a sealing sleeve at least partially enclosing the tubular body;
a material connection between the sealing sleeve and the tubular body providing a leakage-free connection at pressures of at least 700 bar and relieving the tubular body from axial loads; and
a housing defining a fluid passage, a sealing cone configured to receive the sealing sleeve, an annular chamber configured to encircle a portion of the sealing sleeve when the sealing sleeve is received in the sealing cone, and a vent bore opening into the annual chamber.

2. The high pressure screw connection according to claim 1 characterized in that the material connection is one of the following connections:
a soldered connection;
a welded connection;
a glued connection; and
a vulcanization connection.

3. The high pressure screw connection of claim 1 characterized in that the material connection comprises a weld seam.

4. The high pressure screw connection of claim 1 characterized in that the sealing sleeve comprises grooves on one side facing away from the tubular body.

5. The high pressure screw connection of claim 1 characterized in that the tubular body has a fitting contour on the side facing away from the sealing sleeve.

6. The high pressure screw connection of claim 1 characterized in that the sealing sleeve is slid fully onto the tubular body.

7. (canceled)

8. The high pressure screw connection of claim 1 characterized in that the tubular body is inserted with the sealing sleeve into the housing.

9. (canceled)

10. The high pressure screw connection of claim 1 characterized in that the sealing sleeve further comprises an annular shoulder, the high pressure screw connection further comprising a sealing ring at least partially enclosing the sealing sleeve and axially constrained by the annual shoulder, the sealing ring engaging the sealing cone when the sealing sleeve is inserted into the sealing cone of the housing.

11. The high pressure screw connection of claim 19 characterized in that a thread locker consisting of two disks is provided between the sealing sleeve and the screw.

12. The high pressure screw connection of claim 19 characterized in that an end of the screw mating with the housing encompasses at least one of the sealing sleeve and the threaded locker in the axial direction.

13. (canceled)

14. The high pressure screw connection of claim 1 characterized in that a housing is arranged in a straight manner, in a bent-off way, as a T-element or as a crosspiece.

15. The high pressure screw connection of claim 1 characterized in that the sealing ring is fabricated from a pressure-resistant plastic material.

16. The high pressure screw connection of claim 1 characterized in that the sealing sleeve is slid with a tight fit onto the tube.

17. The high pressure screw connection of claim 10 wherein at least one of the annual shoulder and the sealing ring engage the sealing cone to form a seal.

18. The high pressure screw connection of claim 10 wherein the sealing ring has a conical outer shape mating with sealing cone in a complimentary manner.

19. The high pressure screw connection of claim 1 characterized in that the housing includes a threaded portion, the high pressure screw connection further comprising a screw mating with the threaded portion of the housing to secure the sealing sleeve in the sealing cone.

20. The high pressure screw connection of claim 19 characterized in that the screw member is a threaded nut.

21. The high pressure screw connection of claim 15 characterized in that the sealing ring is fabricated from polyether ether ketone (PEEK).

22. The high pressure screw connection of claim 16 characterized in that the differential tolerance between the outside diameter of the tube and the inside diameter of the sealing sleeve is less than 1 mm.

23. The high pressure screw connection of claim 16 characterized in that the differential tolerance between the outside diameter of the tube and the inside diameter of the sealing sleeve is less than 0.1 mm.
